(19) United States
(12) Patent Application Publication
(10) Pub. No.: US 2015/0286943 A1
(43) Pub. Date: Oct. 8, 2015

(54) Decision Making and Planning/Prediction System for Human Intention Resolution

(71) Applicant: AI Laboratories, Inc., Duluth, GA (US)

(72) Inventors: James Qingdong Wang, Duluth, GA (US); HongJhe Chen, Duluth, VA (US)

(73) Assignee: AI Laboratories, Inc., Duluth, GA (US)

(21) Appl. No.: 14/246,113

(22) Filed: Apr. 6, 2014

(51) Int. Cl. G06N 5/04; G06F 3/0484; G06F 3/0482

(52) U.S. Cl. CPC G06N 5/045; G06F 3/0482; G06F 3/04842

(57) ABSTRACT

Embodiments of the present invention provide unique artificial intelligent information processing models. These include: the planning processing model and summarization model, where it accepts a sentence or phrase from the user, looks for the root concept of representation, enumerates related things for the concept, organizes a plan as possible steps to implement the concept, and recommends related information or detail description based on the plan. It also includes an execution module, which provides details to the user to fulfill the objectives.

### TECHNICAL FIELD

Example embodiments (Decision Making And Planning/Prediction System for Human Objective Resolution, also referred to as a Decision System) relate to a unique artificial intelligence (AI) application in that through a specially designed user interface and information processing algorithm, the application system simulates human intelligence to make decisions, predict possible happenings, and produces plans for the requested objective, or in some degree executes to fulfill the user objective.

### BACKGROUND

Current AI applications in practical usage are very limited. For example, the existing information processing such as a Google search is based on a ranking mechanism from frequency of hits on phrases, and the Siri virtual assistance is based on certain limited usage cases with relative information. Those systems usually can't understand a particular question or sentence from user input, and thus are unable to process user requests accordingly, nor able to prepare implementation procedures or schedules for execution of the searched objective.

For example, if a user request is to make a storage shelf in a garage, Siri will be unable to produce clear, reasonable or logical procedures to fulfill this objective.

Thus, a practical AI application that can 1) parse the input sentence properly, and understand the user's request, 2) Analyze each concept and task objective, 3) have an automatic planning mechanism based on user objectives, which can plan and list the steps in a proper sequence, and prepare a schedule for execution and implementation 4) have an automatic execution procedure preparation mechanism, which can prepare the approaches and procedure for fulfillment and implementation.

### SUMMARY

In some examples, existing available applications requires users to enter their request in terms or phrases that the application can recognize; while for any terms that the application can't recognize through its limited algorithm or machine learning system, current applications available on the market are unable to process the request in a proper and intelligent manner.

Thus an intelligent application system is needed, wherein based on a user's request inputting a phrase, sentence or paragraph, the application runs through its artificial intelligence algorithm for parsing and recognizing the user's intention, finding the most appropriate answer, planning and scheduling for the task objective, and preparing an execution procedure to fulfill the requested objective.

Embodiments of the present invention provide unique artificial intelligent information processing models. These include: the planning processing model and summarization model, where it accepts a sentence or phrase from the user, looks for the root concept of representation, enumerates related things for the concept, organizes a plan as possible steps to implement the concept, and recommends related information or detail description based on the plan. It also includes an execution module, which provides details to the user to fulfill the objectives.

This application system understands user request input, calculates/plans how many tasks/steps should take to fulfill the request based on its database and resolution engine, then gives users the results with an execution procedure and schedule.

Specifically, some examples are illustrated in the following: e.g., intelligent calendar/personal assistant: User has a vague idea on what needs to be achieved ahead, however the user is not clear on when and what is the best plan to achieve it, or what is the most efficient way for execution, e.g., a purchase plan: User wants to purchase a hybrid car, but might not be sure what is the best way or steps involved.

The embodiment has the capability to process information, make decisions, prepare an execution plan, and with certain capacity, predict for users.

These characteristics will be apparent from a reading of the following detailed description, and a review of the associated drawings. Other systems, devices, methods, and features of the invention will be or will become apparent to one skilled in the art upon examination of the exemplary following figures and detailed description. It is intended that all such systems, devices, methods, features be included within the scope of the invention, and be protected by the accompanying claims.

### DESCRIPTION OF THE DRAWINGS

FIG. 1 is a screen shot illustrating an example of an interaction between a user and a decision system in a planning assistant interface, according to at least one embodiment.

FIG. 2 is a screen shot illustrating an example of an interactive menu for displaying detailed summary information according to one schedule item, according to at least one embodiment.

FIG. 3 is a flow diagram illustrating an example sequence of a conversation between a user and a system, in addition to illustrating a final planning result, according to at least one embodiment.

FIG. 4 is a block diagram depicting a distributed network for a server client architecture illustrating several different types of clients and modes of operation, according to at least one embodiment.

FIG. 5 is a block diagram depicting an architecture for implementing at least a portion of a system according to at least one embodiment.

FIG. 6 is a flow diagram depicting a method of complex input processing for parsing received inputs from each user interface, extracting user intent and determining further operations according to at least one embodiment.

FIG. 7 is a flow diagram depicting a method of a planning process for producing a planning list, schedule, or other kind of sequential results according to a user's intention, according to at least one embodiment.

FIG. 8 is a flow diagram depicting a method of summarization processing for producing detailed instructions or other kind of information to the user, according to at least one embodiment.

### DETAILED DESCRIPTION

Embodiments described herein facilitate the artificial intelligence application in processing complicated task requests, such as event calendar planning (e.g., a Russian/or European backpack trip planning, etc.), wherein users might be unclear about the details/steps related to the objectives. Such subjects might not be in the commonly seen categories of services like Siri, resulting in the topic being hard for current IT application systems to process. With the embodiment application here, information can be processed properly, while a plan and execution can be prepared to meet a user's requests.

This Decision System can operate on mobile, online, cloud or on other various hardware devices/platforms. The answers this application provides to users might be in the form of 1) more appropriate information; 2) detailed approaches/steps to execute the task and fulfill the objective; 3) overall plans, including instructions, diagrams, examples, suggestions on the execution and implementation of the objective, references on the subject including community news/comments; 4) the scheduling of the implementation process including where, when, how to best implement the objectives; 5) related products, communities or other information that users might find useful for their needs; 6) execution of the tasks in some capacities on behalf of the user.

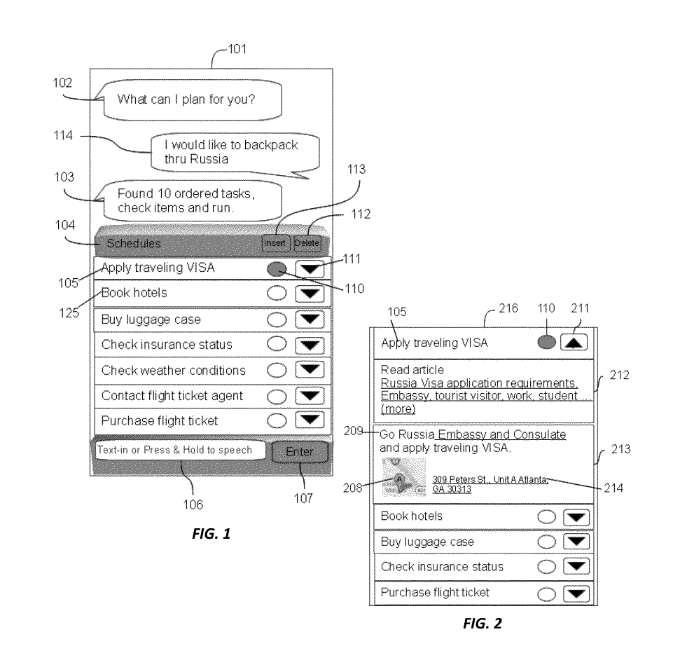

In the following detailed description, references are made to the accompanying drawing FIG. 1 that form a part hereof, and in which are shown by illustrating specific embodiments or examples for the task of backpacking in Russia. The inquiring user is referred to as “user” for simplicity, the AI application system that the user interfaces with which processes the application here is referred to as “system” for simplicity. The main steps are shown in the figures as a “white box” or a “block”, the decisions in the procedure that system makes is shown as a “diamond.” The following are three example dialogues for the FIG. 1 application, which is between the user and system on specific task processing; all three examples may contain complex words or phrases, and plural or singular nouns.

### EXAMPLE 1

Using the “Backpack in Russia” as an example process. In FIG. 1, after the system starts by asking user 102, user inputs a request to “backpack thru Russia” 114. The system gets the intention of the user, then processes this from its database and resolution engine, finds ten steps of tasks in proper order to fulfill objective planning 103, including applying for visa (non-visa waiver program), book hotel, buy luggage, check insurance status, contact flight ticket agency, purchase flight ticket, check weather conditions, where and what to see in Russia, etc. . . . as a example list 104.

And for each step that the system lists, relative details and specific information to execute the steps are also provided by the system (e.g., applying for a traveling visa, 105 (FIG. 2) provides more specific details including Russian visa application requirements, nearby embassy or consulate information, etc.).

### EXAMPLE 2

Using the “Buy a Hybrid Car” as an example process. Similar to Example 1, a user inputs a request to “buy a hybrid car.” System first resolves to grasp the intention of the user, then processes from its database and resolution engine, and finds several steps of tasks in proper order to fulfill this objective planning, including evaluate financial status, study different models of hybrid car, go to car dealers, purchase car, purchase car insurance, etc.

And for each step that the system lists, specific details and information to execute the step is also provided in the system (e.g., on personal financial help, it provides more specific details including banking information and special offers for car loans, etc.). Each recommendation in the suggested list may cover best pricing, best hybrid car dealer, or other related scenarios, etc.

### EXAMPLE 3

Using the “Lose 50 Pounds Within Three Months” as an example process. Similar to Example 1, user inputs a request to “lose 50 pounds in weight in three months.” System gets this intention of the user, then processes from its database and resolution engine, and finds several steps of tasks in proper order to fulfill this objective planning, including to do more excise, reduce calorie intake, etc.

And for each step that the system lists, specific details and information to execute the steps is also provided in the system, e.g., on the excise suggestion, it provides more specific details including at least one effective excise and a detailed plan for a duration of three month, etc. Each recommendation in the suggested planning list may cover the best method to lose weight, best quantities of exercise, and specific methods to achieve/complete the objective within three months, or other related conditions, etc.

As in some of above examples, the planning result 104 is not restricted only in a schedule list, or just one kind of representation. For example, a timeline view may be presented to the user for illustrating a span of a personal schedule with a suggested time plan, and the like. For different presentations of a planning result, the system may offer different kinds of user control objects, for example, a radial box 110 can be used for selecting a planning item, a switch button 111 can be used for displaying a summarization menu, an insert button 113/delete button 112 can be used for insert/delete selected item, and the like.

In addition, each item in the planning result is not restricted to only a short sentence; the sentence can include more information advising the user. For a specific example of a sentence of “Book hotels with one family room in downtown Moscow”, the system can perceive that the user may require a family room and, based on the itinerary of user's trip, prompt the user for more complete information which is comparable to that shown in 125 (FIG. 1) for giving precise instructions to the user. Furthermore, the system may display a map, address book, other kind of media or appendix append to each item of planning result, and the like.

Although the input interface in FIG. 1 is shown as a text box 106 with a submit button 107, the input method is not restricted to only typing text input. Further input methods include voice recognition, handwriting recognition, or other input methods. For example the input interface in FIG. 1 can support voice input, as the following exemplary describes: a user presses the input box 106, holds the action, and continue to speak until the sentence(s) is complete, and then release the text box 106. Afterwards the decision system receives the same input via a voice to text process, and proceeds to further process the input. Furthermore, the input language is not restricted to only English. Other languages or mixed language input is acceptable in example embodiments.

In an example screen shot 216 in FIG. 2, when a user clicks on a switch button 211, the Decision System displays a summary result in a pull-down menu containing two suggestions (212 and 213). Furthermore the Decision System updates interactive elements on the screen, and the switch button 211 can change the icon with a collapse function to handle the sub menu.

The summary menu (212 and 213) is not restricted only for displaying a plain text or visual forms. For example, a map, an address book, a phone book, a weather forecast data, an embedded media player, dynamic data, or other related information, can be produced for the user with different scenario or stories.

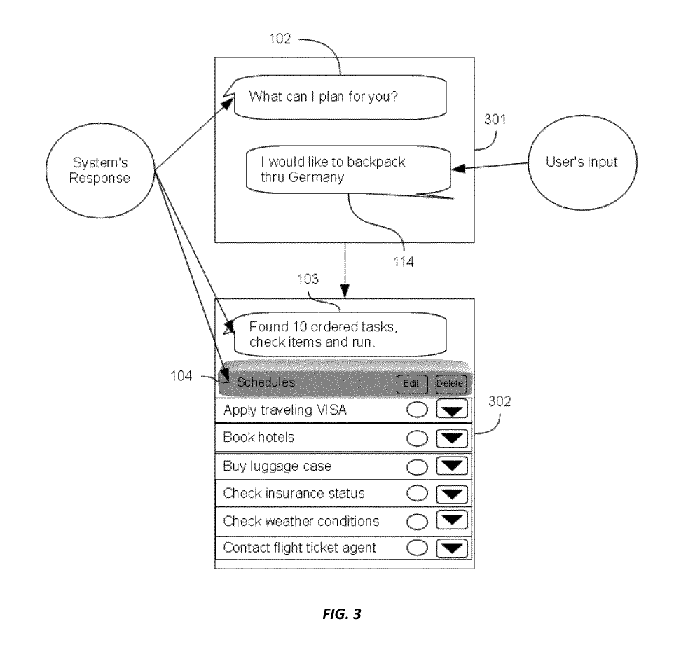

Referring now to FIG. 3, there is shown a flow diagram depicting a series of screen shots of an example interaction between the Decision System and a user according to one scenario of the paradigm presented in FIG. 1. The diagram illustrates a sequence order of two interactive stages. The first stage is a dialogue session 301 for retrieving and classifying the user's intent for determining further operation. Suppose the user's input is ambiguous 608. The system can converse with the user shown at 606 in a natural language format to clarify the user's intent until the user's intent is clear and sufficient to be understood by the system. Otherwise the system can also generate another question(s) or other/more feedback to the user within the session 301.

Although the example 102 and 114 is shown as a simple sentence in the dialog session 301, the conversation is not restricted in sentence structure or language form. Further complex sentences, complicated language structures, and characters or symbols can be accepted as input/output within the dialog session 301.

The second stage, an example of which is shown in FIG. 3, can be a planning result presentation 302 for outputting suggested results to the user. In this example, the system generates a summary message 103 that can accompany a representation of the planning result 104. For different scenarios and user profiles, the decision system can produce a different language, different type of message, or a different planning result representation that is suitable for that user's interpretation.

### Network Infrastructure(s)

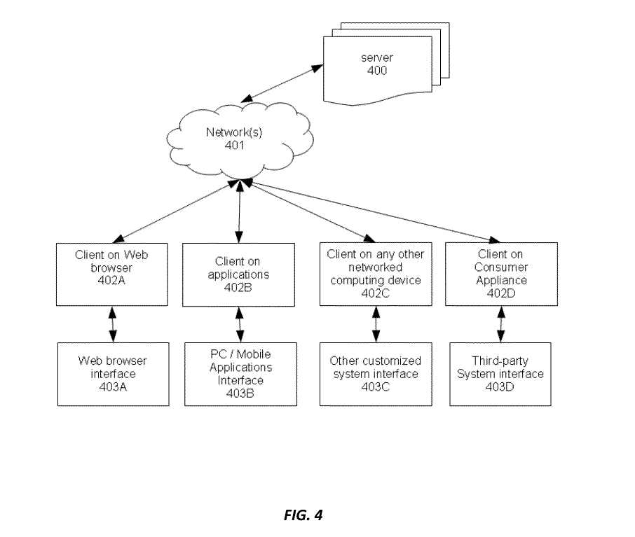

Referring now to FIG. 4, a block diagram shows an example of a distributed network suitable for implementing Decision System features and functionalities disclosed herein. The Decision System server(s), referred to as server 400, can be a computer or multiple computer pools implemented with a Decision System server software portion in a network. The server can be re-configured for different applications or different purposes, e.g., high performance computing servers for decision making or machine learning platform, real-time data mining servers for data collection, clustering servers for advanced database service on decision system, and the like.

In example embodiments, the server 400 hosts multiple decision system services, accommodates multiple client connections simultaneously. Server 400 communicates with third-party databases, computing alliance or other servers in the network.

In example embodiments, the server 400 may collect personal data, access client devices, or monitor activities on each client for advanced data analysis and client controls. Server 400 can further integrate network configuration, manageability and other features. For example, the decision system server 400 may terminate communications with unauthorized clients for one or more security reasons to protect the Decision System.

According to example embodiments, at least a portion of the various types of functions, operations, actions, and/or other features provided by Decision System may be implemented at one or more client system(s), at one or more server system(s), and/or combinations thereof.

The computer network(s), referred to as network 401, can support data transportation, data exchange, device communications or other networking protocols, and the like. The network can comply with different network convention(s) in different embodiments, examples of which include TCP/IP based Internet, intranet, or a particular IPX/SPX based local area network.

Although the network topology shown in FIG. 4 illustrates point-to-point connections between each computer, it is not restricted to only one network arrangement. The logical topology of a point-to-point connection shown in FIG. 4 can be a physical topology of ring deployment enclosed from the view of networking equipment. For either logical or physical topology, the layout can be different in an identical network, the decision system can be implemented in various types of network topologies. Such network topologies can include: a point-to-point network, a bus network, a star network, a ring network, a circular network, a mesh network, a tree network, a hybrid, or a daisy chain network.

Although the network deployment shown in FIG. 4 illustrates a server-client architecture, application or components in the Decision System are not restricted to only this kind of network architecture. For example, applications in the Decision System can be implemented on a peer-to-peer network, a grid computing network or other type of network deployment.

The Decision System client, referred to as client 402, can be a computer, mobile device or other computing device(s) implemented with a portion of the client part of decision system software and/or hardware in a network. Each client may integrate one or multiple user interfaces, further interactive to the end user.

Also referring to FIG. 4, the architecture can have web browser interface 403A and web client 402A. This kind of solution enables a user access to a Decision System server 400 via a web browser; for example a user may execute an embedded web browser in a mobile device, or a pre-installed Internet web browser in a computer, to connect to the Decision System server, and then proceed with further operations of the mobile device.

Also referring to FIG. 4, the architecture can have application interface 403B and application client 402B. This kind of solution enables a user access to Decision System server 400 via a user-end software or other bundled software, for example a user may execute a pre-installed decision system application in a personal computer, mobile or other devices to connect to the decision system server, and then proceed with further operations of the mobile device.

Still referring to FIG. 4, the network architecture can have interface 403C and client 402C. This kind of solution enables a user access to decision system server 400 via a specific client interface. For example a user may operate on a customized device, using an embedded system, industrial PC, or other networked devices to connect to the decision system server, then proceed with further operations.

Also referring to FIG. 4, the network architecture can have interface 403D and client 402D. This kind of solution enables a user access to decision system server 400 via third-party software(s). For example, a user may login to Facebook to interact with a web application or other elements on that website. Meanwhile an intermediate decision system model may assist the data processing and computation, and then proceed with further operation associated with Facebook.

### System Architecture(s)

The Decision System may be implemented on hardware, or a combination of software and hardware. For example, the Decision System may be implemented in an operation system kernel, in a separate user process, in a library package bound into network application, on a specially constructed machine, or on a network interface card. In example embodiments, the techniques disclosed herein may be implemented by software, such as an operating system or in an application running on an operating system.

In example embodiments, the decision system integrates with multiple components. Each component may be located inside a decision system or be implemented into an external system, sub-system, or third-party application(s).The connection between each system, or application, can use a variety of communication methods, including, for example, a decision system that can access/stream to the external system via specific network conventions and protocols.

In example embodiments, the decision system can be re-deployed and/or re-configured for different applications. For example, adding a visual time-line object and extra scheduling logic to the Decision System and configured as a sophisticated calendar application, etc.

In example embodiments, the decision system can integrate into expert systems and deep knowledge reasoning frameworks. It can collaborate with other platforms or external resources, providing precise and high quality planning prediction or summarization in great detail.

In example embodiments, the decision system can be implemented to a multi-lingual system further comprising multi-language user interface and multi-language sub-systems, which is not restricted only in a natural language operation. For example, the system can include a version of Chinese-based user interfaces, messaging sub-system, speech recognition, speech synthesis component, etc.

Examples of different types of input data/information which can be accessed and/or utilized by Decision System can include, but are not limited to, one or more of the following (or combinations thereof):

Voice input: from mobile devices such as mobile telephones and tablets, computers with microphones, Bluetooth headsets, automobile voice control systems, over the voice recognition system;

Text input: from keyboards on computers or mobile devices, keypads on remote controls or other consumer electronics devices, and text streamed in message feeds. Further examples include a command line interface (CLI) or other input methods from a user;

Clicking any menu selection and other input events from a graphical user interface (GUI) on any device having a GUI. Further examples include touches to a touch screen.

Messaging and other API communications from a software or information adapter on any third-party application. For examples, an application or widget in Facebook.com requesting a planning service to the Decision System via a specific protocol or communications, the decision system provides computing service in back-end in this case.

Examples of different types of output data/information which may be generated by Decision System may include, but are not limited to, one or more of the following (or combinations thereof):
a. Text and graphics output sent directly to an output device and/or to the user interface of a device;
b. Text and graphics sent to a user over a messaging service or other specific networking protocols.
c. Speech output, which may include one or more of the following (or combinations thereof):
d. Synthesized speech;
e. Sampled speech.

Graphical layout of information, including photos, rich text, videos, sounds, and hyperlinks. For instance, the content can be rendered in a web browser.

Invoking other applications on a device, such as calling a map service, sending an email or instant message, playing media, making entries in calendars, task managers, and note applications, and other applications.

According to different embodiments, at least a portion of the various types of functions, operations, actions, and/or other features provided by Decision System can be implemented by at least one embodiment of the procedures illustrated and described in this application.

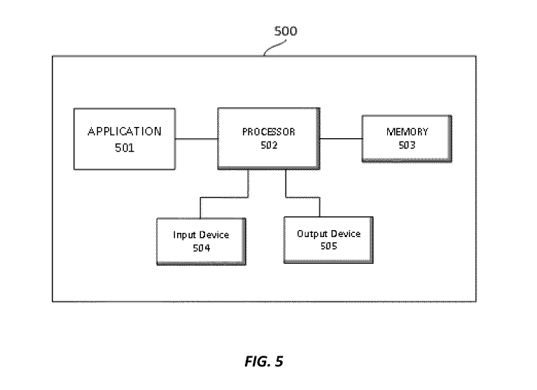

FIG. 5 is a block diagram representation of an example computing device 500 that can implement example embodiments of the present invention. The system 500 can have one or more memories 503, one or more central processing units (CPUs) 502, one or more input devices 504 (e.g. keyboard, mouse, hand writing recognizer, speech recognizer), and one or more output devices 505 (e.g. graphical user interface, speech synthesizer).

In the computing device 500, the CPU(s) can execute the application for decision making processing disclosed herein, interact with the user via the input/output device, and produce proper results to the user.

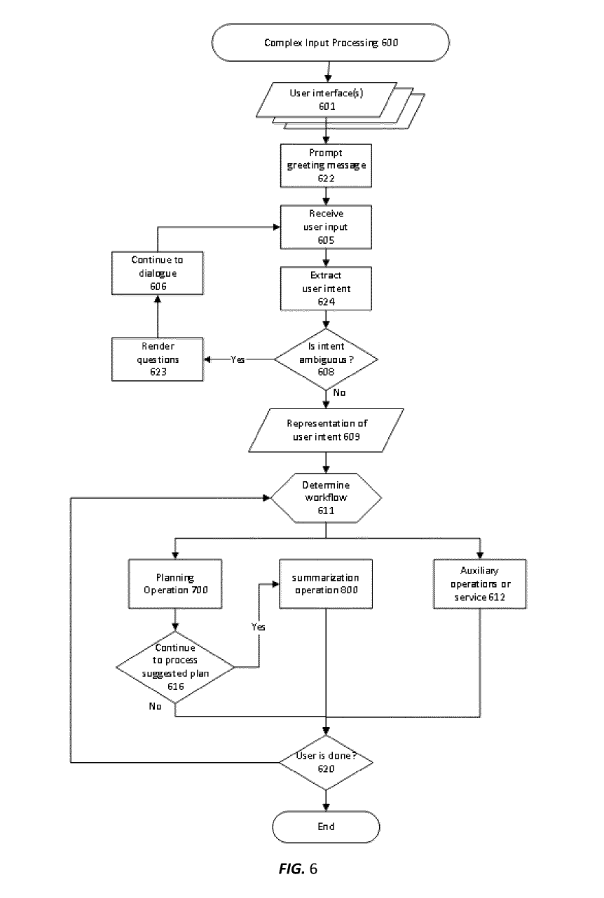

Referring now to FIG. 6, an example method for complex input processing is shown. The method begins from 600 to handle the user's input or interaction on each user interface 601. First, the system can prompt a greeting message 622 notifying the user start to inputting their intent in a form of natural language; then it can parse the input language to a representation of user intent 609. If the input is ambiguous 608, the system generate questions to clarify user's intent 623, make conversation with the user 606, read the input buffer 605, and continue to extract user intent 624 until the intent is clear or the dialogue session is finished.

User intent extraction 624 can be a language understanding logic, comprising a natural language processing pipe, with at least one grammar parser and at least one reasoning component. The natural language processing pipe performs a series of natural language processing tasks, including analyze language words and syntax, label computational symbols, execute other syntactic/semantic parses on the input language; meanwhile the grammar parser(s) parses the language structure and semantic meanings, including detect dependencies between each word (ex. a Relational Grammar Theory of direct objects, indirect objects or auxiliary objects, etc.), classify semantic relations (ex. Homonymy, Synonymy, Antonymy, Hypernymy, etc), or predict semantic roles in the input language, and the like.

After the decision system extracts adequate language information via the language processing as above, the reasoning component(s) parse the concept of the input language, and classify ambiguous sentences (disambiguation), etc. for understanding every language input of user's intent.

The representation of user intent 609 is a knowledge representation, comprising previous language parsing results, semantic notations, at least one linguistic formal system and at least one ontology. The linguistic formal system is a linguistic system for rendering an abstraction form of natural language, for example, a well-known First-Order Logic is one kind of formal system for producing logic based language abstraction. The ontology is a set of concepts for knowledge representation, for example, a word-sense ontology gives a word “backpack” two concept of knowledge, with one being a verb for travel, while another a noun for a sack, etc.

After the decision system generates the representation of user intent 609, the decision system can perform deep knowledge reasoning via specific algorithms, for example, a computational logic for logic-based reasoning, etc.

After the system derives a representation of user intent 609, the system determines at block 611 two or more of the following operations for the user: A planning operation 700, wherein the system continues to process the user's intent, and produces a recommendation list ordered for the fulfillment/execution of the tasks relating to the objective. In addition the system may proceed 616 to summarization operation 800 for generating detailed instructions if the user requests to view the detailed implementation procedure of each item in the planning list (i.e. if the user presses the switch button 111 in FIG. 1, and chooses to view the detailed instructions 212 and 213). The other auxiliary operation 612 is an operation whereby the system can launch other operations for the user, for example, share planning results to other friends or related social networks, edit or maintain the planning results, configure notifications or alerts, login to the Decision System, send planning results to the user's personal calendar, etc. The above operation can be implemented with a variety of different interfaces. Some operations may use extra logic, and the like.

The system may continuously maintain a loop of the workflow 611, until the session of user interaction is complete, or the operation is finished.

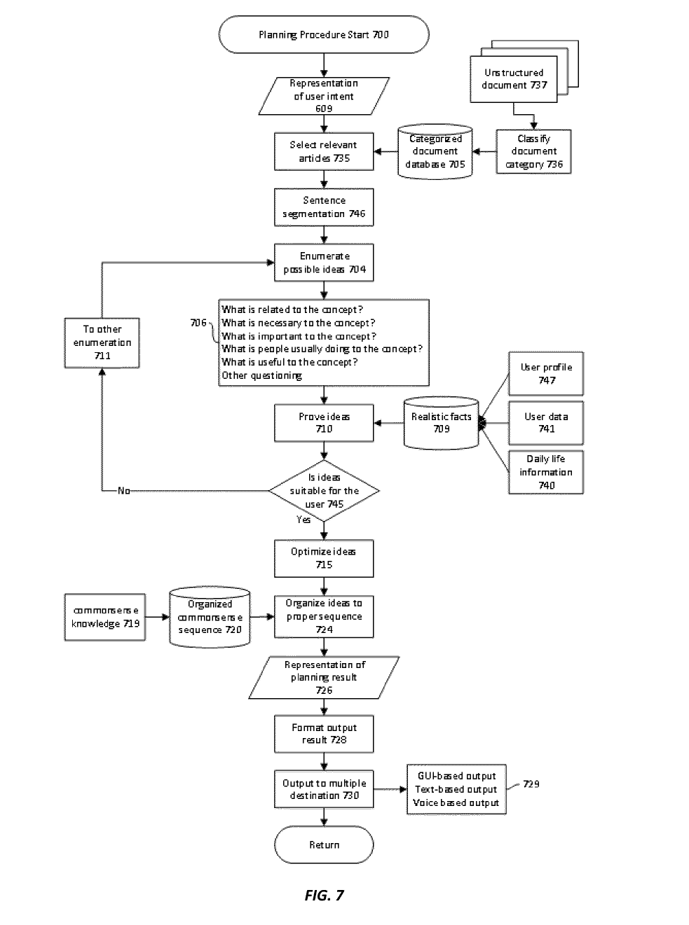

Referring now to FIG. 7, a flow diagram depicting an example method for planning processing is shown. The method begins with 700. When a user chooses the planning operation 700, the planning process receives the representation of user intent 609, enumerates relevant and possible ideas from a questioning-based logic 706, prepares plans via the following categories or aspects of “What is related to the concept(s)”, “What is necessary to the concept(s)”, “What is important to the concept(s)”, “What are people usually doing for the concept(s)” and other various categories, then organizes the plans accordingly into a proper list 724 and provides the list to the user (e.g., as shown in element 104 in FIG. 1).

Continuing with the planning process 700, the process can at stage 735 select relevant articles by drawing from unstructured document 737, which can be a collection of unstructured language documents including corpora, web pages, books, or other human readable data, etc., from various origins or sources (for example, an internet website or encyclopedia, and the like). After the document collection process, a classifier 736 analyzes the semantic meaning through numerous unstructured document(s) 737 above, classifies the document categories and stores the documents into a proper index of categorized documents database 705 for use in the main process of planning processing.

In at least one embodiment, the article selector associated with the select relevant articles 735 stage is a preprocessor for importing suitable language sources or documents into the main planning process. First, the selector examines the representation of user intent 609 for seeking the goal and motivation, classifies the possible category of the knowledge, and incorporates the corresponding language source into the main planning process. The classifier may use some well-known probability models or ontology existence reasoning algorithm, etc.

After the system selects a relevant language source(s), at the sentence segmentation stage 746, a well-known sentence segmentation parser starts to parse the language source to break down documents, corpora or other language sources into a sentence segmented format for further processing.

Next, at the enumerate possible ideas stage 704, an enumerator includes a core method for listing candidate resolutions in the planning process. The enumerator begins at 704. First it receives the selected relevant, and segmented language source from stage 746. Then, it sets up the goal(s) by some customized designed questions in 706. Then, it compiles the goal(s) with user intent to a type of solver, e.g., a context matcher, or logic based classifier, etc. After the process, the Decision System can start to locate goal-related context over the language source, classify semantics on the retrieved content, and list the results as candidate resolutions against the user intent input. In addition, the enumeration process from 704 may continue to run until the listing result is satisfied with a number of ideas or other conditions setup in the planning process procedure 700.

Referring to FIG. 7, in at least one embodiment, the user profile 747 can include a collection of profile data regarding the user, such as the user's interests, favorites, habits, age, gender, backgrounds, etc. The system can collect this user profile information via multiple sources, including external third party databases, social networks and/or from user inputs, such as using a questioning logic interactive with the user.

In at least one embodiment, the user data 741 can include a collection of the user's personal schedule, location information, financial status, health reports, etc., the system may collect this data from multiple sensor devices and/or analyze the user's profile 747 to create user data via the inferred results, and the like.

In at least one embodiment, the daily life information 740 can include a collection of information for everyday human life. For example, the dataset may contain traffic news, weather forecasts (hourly, daily, monthly), public transportation routes, and other facts, etc.

Based on the above data collections, the system stores those data, properly indexed, into a realistic facts database 709 for the main planning processing procedure to use. In addition, the Decision System can maintain each collection in system runtime, and update each collection dynamically to account for real-time change.

Continuing to the next step of the main planning procedures process, the Prove Ideas stage 710 includes reasoning logic for comparing candidate ideas with numerous realistic facts at stage 709, using statement logics to classify which listed idea(s) is suitable at stage 745 for the user and determines whether to drop ideas or continue 711 to enumerate other language source.

Next, the optimizer 715 includes an optimization process to add more complete concepts to the listed idea, and additionally, patch the original idea to become a proper representation of the language.

In at least one embodiment, the commonsense knowledge collection 719 has a collection of statements of commonsense knowledge including numerous prepositional phrases, phrases, corpora or other type of language form. Each statement contains a part of description of how each element depends from the other. For example the statement “Buy a car should earn money first” depicts the dependency and relationship between the concept “buy car” and “earn money,” and the like.

Based on the above statements, the organized commonsense sequence 720 shows a database, whereby a process to store statements into a proper index in the database, composes a fast referential database for sequence reasoning, dependency reasoning through knowledge of each statement, and the like.

Continuing to the next step of the main planning process, the stage/step 724 includes a sorting process for organizing ideas into a rational result by referring to the organized sequence knowledge database 720. After the system rearranges the sequence of ideas, the system renders a final representation of planning result at stage 726. In addition, it translates ideas to a form of natural language in the representation at stage 726.

Next, the output formatter 728 includes transformation logic for rendering at least one presentation of the output. The output presentation can be, for example, a to-do list, a checklist, an integration of a personal calendar or other type of representation to the user, and the like.

Finally, the output multiplexer 730 includes an output controller for transferring the presentation to at least one output device 729, including GUI-based output, text-based output and voice-based output, etc.

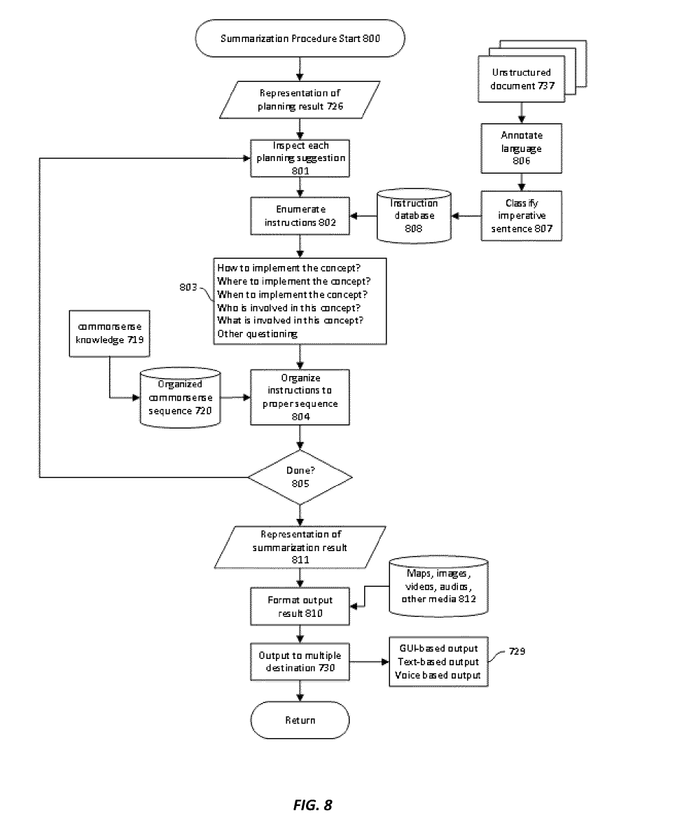

Referring now to FIG. 8, a flow diagram depicting an example method for summarization processing is shown here. 800. After the system finished planning processing 700, a condition logic 616 (FIG. 6) may take control and continue to the summarization operation 800. Meanwhile the summarization process 800 receives the representation of planning result 726 (FIG. 8) which is rendered by the planning processing 700 in FIG. 7, inspecting each planning suggestion(s) in the planning result 801 and enumerate possible instructions 802 for each planning suggestion from a questioning based logic 803, prepare instructions via following categories or aspects of “How to implement the concept(s)”, “Where to implement the concept(s)”, “When to implement the concept(s)”, “Who is involved in this concept(s)”, “What is involved in this concept(s)” and other various categories. The Decision System then organizes the instructions accordingly into a proper list 804, and provides the list to the user (as the example 212 and 213 in FIG. 2).

Continuing on with the summarization process 800, the annotator 806 includes a natural processing method for parsing and annotating sentences in the collection of unstructured document 737. At this step, the system uses many well-known natural language processing parsers (e.g., POS tagging, co-reference resolution, semantic role labeling, etc.) to perform syntactic and shallow semantic parsing, and provides the results to further language classifier 807.

In at least one embodiment, classify imperative sentence 807 includes a sentence classifier for extracting imperative sentences from the annotated language source, analyzing the sentence structure, and storing the sentence into an instruction database 808 for the further summarization processing procedure to use.

After the system collects an amount of instruction sets in the database 808, the Decision System is able to process each planning suggestion 801, suggest detail instruction accordingly in the summarization processing procedure 800.

Next, the enumerator used in stage 802 can include a method listing possible instructions for the representation of planning result 726. The enumerator can use questioning logic 803 to set up the goal and target for the enumeration process, compile the questions into a logic statement, parse each planning suggestion from the loop 801, repeatedly match and select suitable instructions for each item, and provide the results for further processing.

Next, at 804, there is performed a sorting process for organizing instructions to a rational result by referring to the organized sequence knowledge obtained from 720 (as explained in FIG. 7). After the system rearranges the sequence of instructions on each item 805, the system renders a final representation of summarization result at stage 811.

Next, the output formatter 810 includes presentation logic for rendering at least one presentation of the output. Additionally, it integrates proper media 812 into the representation. For example, the system attached both a map 208 and an address book 214 into the presentation of recommended instructions 209 in FIG. 2, and the like.

Finally, the output multiplexer at stage 730 includes an output controller for transferring the presentation to at least one output device 729 (same as the explanation in FIG. 7), presenting the results to the user.

What is claimed is:

1. A system for receiving user inputs, determining the user's intent, and rendering output data related to the user's inputs comprising:
an intelligent decision component that receives an input of a user, wherein the component determines a user's intent;
a planning processing component for determining a result based on the user's determined intent, wherein the result comprises a plan having a list of one or more action items to fulfill the plan; and
a summarization processing component for rendering the result on a computing device accessible to the user.

2. The system of claim 1, wherein the intelligent decision component receives a natural language input from the user.

3. The system of claim 1, wherein the component determines a user's intent based on an interaction with the user comprising questions generated to the user.

4. The system of claim 3, wherein the questions generated depend in part upon unstructured language documents.

5. The system of claim 1, wherein the system generates suggestions before receiving the input from the user.

6. The system of claim 5, wherein the suggestions are based on one or more of a user's profile, a user's input history, language grammar analysis, language correction, or a probability method.

7. The system of claim 1, wherein the list of action items is in an order in which each step must be accomplished sequentially to execute the result.

8. The system of claim 1, wherein the plan comprises or more of a:
a travel plan;
a study plan;
a work plan;
a manufacturing plan;
a fabrication plan;
a research plan;
a shopping plan;
a networking plan; and
an entertainment plan.

9. The system of claim 1, wherein a user can interact with the results by one or more of: share the results with a social network application; email the result; text message the results;
and add the results to a calendar application.

10. The system of claim 1, wherein the intent of the user is derived using a concept representation component to interpret the user's input based upon one or more of:
a profile analysis;
common-sense knowledge representation;
semantic reasoning;
domain knowledge representation;
ontology reasoning; and
news.

11. The system of claim 1, wherein the rendered results are from one or more of the following categories:
what is related to a concept of the user's input;
what is necessary to the concept of the user's input;
what is important to the concept of the user's input;
what people usually do for the concept of the user's input; and
special consideration of the concept of the user's input.

12. The system of claim 1, wherein the list of one or more action items associated with the plan comprises one or more of:
how to implement the result of planning processing;
where to implement the result of planning processing;
when to implement the result of planning processing;
who is involved in the result of planning processing; and
what is involved in the result of planning processing.
